(19) United States
(12) Patent Application Publication
(10) Pub. No.: US 2023/0080737 A1
(43) Pub. Date: Mar. 16, 2023

(54) Federated Learning-Based Regional Photovoltaic Power Probabilistic Forecasting Method and Coordinated Control System

(71) Applicant: North China Electric Power University, Beijing (CN)

(72) Inventors: Fang Fang, Beijing (CN); Xiaoning Zhang, Beijing (CN); Yajuan Liu, Beijing (CN); Le Wei, Beijing (CN); Jizhen Liu, Beijing (CN)

(21) Appl. No.: 18/055,414

(22) Filed: Nov. 15, 2022

Related U.S. Application Data
(63) Continuation-in-part of application No. PCT/CN2021/088458, filed on Apr. 20, 2021.

(30) Foreign Application Priority Data
May 27, 2020 (CN) 202010458444.5

(51) Int. Cl. G06N 3/04; G06N 3/08; G06Q 50/06; G06Q 10/04; H02J 3/00

(52) U.S. Cl. CPC G06N 3/0472; G06N 3/08; G06N 3/0445; G06Q 50/06; G06Q 10/04; H02J 3/004; H02J 2300/24

(57) ABSTRACT

Disclosed is a federated learning-based regional photovoltaic power probability forecasting method, mainly comprising steps of: pinpointing all photovoltaic power stations in a region which participate in a federated learning framework for probability forecasting, collecting information within a period of time and corresponding photovoltaic power variables, and sampling the variables according to time sequence into a sample dataset; processing missing values and outliers in the sample dataset resulting from the step; splitting the sample data set of the photovoltaic power stations into a training set and a testing set according to a preset proportion; normalizing the training set and the testing set, respectively; creating a federated learning framework; building, by a central server, a global forecasting model based on forecast requirements, defining a training error function and a precision requirement, and distributing the network architecture and initialized parameters to all photovoltaic power stations.

### CROSS REFERENCE TO RELATED APPLICATIONS

The present application is a Continuation-In-Part Application of PCT Application No. PCT/CN2021/088458 filed on Apr. 20, 2021, which claims the benefit of Chinese Patent Application No. 202010458444.5 filed on May 27, 2020. All the above are hereby incorporated by reference in their entirety.

### FIELD

The disclosure relates to technologies of power production forecasts of photovoltaic plants, and more particularly relates to a regional energy coordinated control system and a federated learning framework-based regional photovoltaic power output probabilistic forecasting method.

### BACKGROUND

Renewable energy integration has always been a challenge to transformation and development of the energy and power industry. In recent years, although government-level policies have been launched to guide integration of renewable energies and tap peak-shaving potentials of various types of energies including thermal power, hydroelectric power, and pumped-storage hydropower (PSH) and efforts have been made to strengthen market regulatability, which have gradually improved integration of renewable energies, there still exist some bottlenecks:

1. Inflexibility of power sources. For examples, flexible power generation sources such as PSH stations and gas power stations in some regions only account for less than 2% of the generation portfolio; particularly in heating seasons, the combined heat and power (CHP) plants are restricted by the operating mode of “determining power generation by heat demand”, which aggravates the peak-shaving pressure of the power system and seriously dampens the potential for renewable energy integration.

2. In conventional technologies for flexible regulation of CHP plants, the thermal storage tanks and electric boilers are inefficient, and transformation of lower-pressure cylinder zero-output and steam generation process meets adaptability challenges.

3. There still lack essential technologies for integrated electricity-heat control in improving flexibility in power generation and heat supply and boosting renewable energy integration.

To meet environment and energy development needs featuring “clean heating” and “renewable energy integration” in cold regions, it is practically important to build up a regional energy coordinated control system, resolve the contradiction between limited regulatability of conventional CHP plants and renewable energy integration, improve operational flexibility of the CHP system, and realize coordination between heat supply and environment protection. To achieve optimum electricity-heat integrated energy efficiency, a regional energy coordinated control system including electric heat pumps relies on accurate forecasting of power output of regional renewable energy sources such as photovoltaic generation, so as to dynamically regulate outputs of various types of energy sources.

Solar energy has a wide application prospect due to its cleanness, renewability, and abundant amount. With constant growth of the scale of renewable energy generation systems, their connection to the power grid imposes an increasingly influence on the power system, such that an efficient forecasting tool is needed. A small-scale forecasting model only covering a specific photovoltaic power station cannot satisfy the need. A forecasting model that can process a large span of geographical regions will become an important support for power production in the future.

Conventional studies of photovoltaic power forecasting mainly focus on certainty forecast (point forecast), i.e., forecasting the output power at a specific location at a certain future time. However, photovoltaic power is susceptible to weather changes and thus has a strong stochasticity and uncertainty; particularly when the weather condition fluctuates frequently or drastically, a point forecast is usually largely discrepant with the observed value, and its accuracy can hardly meet the need of power system operation and dispatch. In addition, although the point forecast provides most important forecast information, the information amount included therein is relatively small compared with probabilistic forecast, such that it cannot reflect operation risks brought by photovoltaic power uncertainty; thus, point forecast is unfavorable to backup decision on power grid operation and can hardly meet the need of secure, stable, and cost-effective operations in the trend of large-scale connection of photovoltaic power generation to the power grid.

Furthermore, the measured weather data and irradiance data are usually scattered in different institutions, resulting in individual data islands; and even inside the same institution, data barriers are hardly broken due to lack of efficient interconnectivity and collaboration. Furthermore, to consolidate and aggregate the data scattered in different regions and different institutions, issues of data privacy and leakage protection arise. Due to privacy, security, and law restrictions, data controllers usually cannot directly share their primary data for model training, seriously restricting artificial intelligence development.

### SUMMARY

The disclosure provides a federated learning-based regional photovoltaic power probabilistic forecasting method so as to at least solve the above problems. The method employs a federated learning framework and a Bayesian long short-term memory (LSTM) neural network so as to enhance forecasting accuracy of short-term regional photovoltaic power by incorporating uncertain consideration while protecting data privacy, and gives probabilistic forecast results under different confidence levels. Under the federated learning framework, the disclosure realizes localized data storage and model training, and globalized model optimization and update. The technical solution of the disclosure is provided below:

A federated learning-based regional photovoltaic power probabilistic forecasting method comprises steps of:

step 1: pinpointing all photovoltaic power stations within a region which participate in a federated learning framework for probabilistic forecasting, collecting weather information and corresponding photovoltaic power variables within a time step, and grouping the variables according to time order into a sample dataset;

step 2: pre-processing the sample dataset obtained in step 1;

step 3: splitting the processed sample dataset of the photovoltaic power stations resulting from step 2 into a training set and a testing set according to a predetermined proportion;

step 4: normalizing the training set and the testing set resulting from step 3;

step 5: constructing the federated learning framework;

step 6: building, by a central server based on a forecast requirement, a global forecasting model;

step 7: defining a training error function, an optimizer, and a learning rate of the global forecasting model built in step 6, and distributing network architecture and initialized parameters to each photovoltaic power station;

step 8: selecting, by the central server based on its communication status with each photovoltaic power station, a plurality of photovoltaic power stations to perform forecasting model training and feedback;

step 9: performing model training and testing using the local training set and testing set prepared in step 4 to each photovoltaic power station selected in step 8, respectively, and updating local forecasting models;

step 10: performing photovoltaic power probabilistic forecasting to each of the selected photovoltaic power stations;

step 11: receiving, by the central server, the local forecasting models in step 9 which pass testing, and updating the global forecasting model;

step 12: distributing, by the central server, the updated global model to all photovoltaic power stations;

step 13: repeating steps 8 to 12 to rolling update the global model.

The disclosure further discloses a regional energy coordinated control system adapted to implement the federated learning-based regional photovoltaic power probabilistic forecasting method stated above, wherein the regional energy coordinated control system comprising: a central server; edge computing nodes of each plant; and communication lines, through which the central server communicates with the edge computing nodes of different photovoltaic plants belonging to different entities; wherein the central server generates a probabilistic photovoltaic power forecast result.

The disclosure offers the following benefits: based on the federated learning framework and the Bayesian LSTM neural network, the disclosure comprehensively considers uncertainty in modeling and data observations while protecting data privacy, thereby enhancing the forecasting accuracy of short term regional photovoltaic power and giving probabilistic forecast results under different confidence levels. With the federated learning framework, the disclosure realizes localized data storage and model training and globalized model optimization and update, which creates a new approach for data sharing and provides more information to assist an integrated energy system to optimize dispatch decisions in real time.

### BRIEF DESCRIPTION OF THE DRAWINGS

FIG. 1 is a block diagram of a federated leaning-based regional photovoltaic power probabilistic forecasting system therefor according to the disclosure;

FIG. 2 is a flow chart of a federated leaning-based regional photovoltaic power probabilistic forecasting method according to the disclosure;

FIG. 3 is a test curve for day-ahead probabilistic forecasting of the weather data and photovoltaic power data collected in Ningxia, P.R. China during the period from July 2006 to November 2018 according to the disclosure, where station A and station B refer to two photovoltaic power station with a distance of 1 km; their installation configurations and data collection manners are completely the same; the two stations and a central server jointly constitute a federated learning framework with the central server.

### DETAILED DESCRIPTION

Hereinafter, the disclosure will be described in detail such that those skilled in the art may understand the disclosure. It is noted that the preferred embodiments described below are only examples, and those skilled in the art may contemplate other obvious modifications.

### Embodiment 1

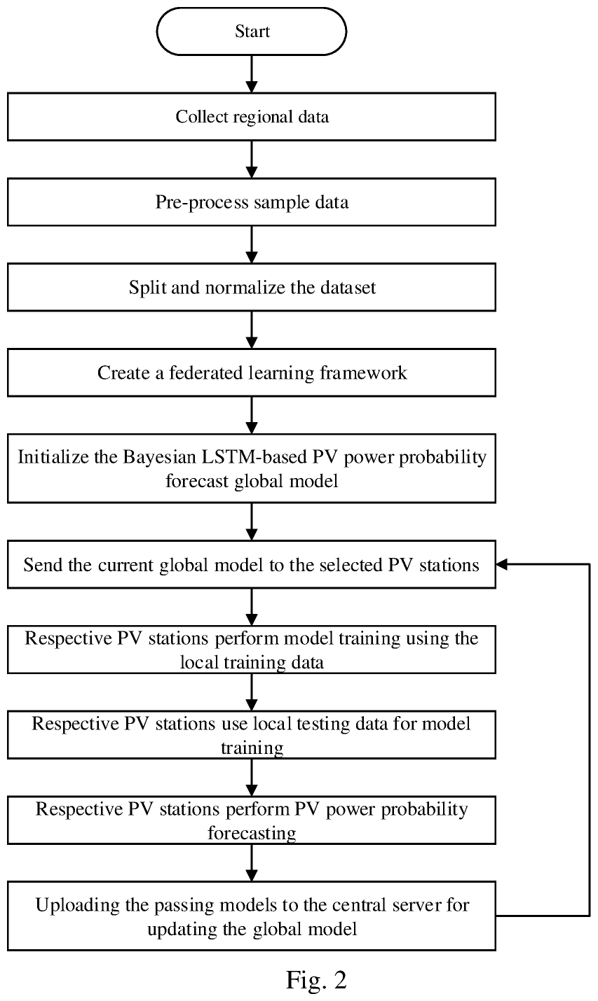

FIG. 2 illustrates a federated learning-based photovoltaic power probabilistic forecasting method, comprising steps of:

Step 1: pinpointing all photovoltaic power stations within a region which participate in a federated learning framework for probabilistic forecasting, wherein the photovoltaic power stations include, but are not limited to, distributed photovoltaic power stations and clustered photovoltaic power stations; collecting weather information of the environment where the power stations are located and corresponding photovoltaic powers within a time step, and grouping the observed weather information and corresponding photovoltaic powers into a sample dataset according to time order, wherein the weather information includes global irradiances, direct irradiances, diffuse irradiance data, atmospheric temperatures, atmospheric pressures, wind speeds, wind directions, relative humidity, and dates and time when the weather information and photovoltaic powers are collected;

Step 2: pre-processing the sample dataset obtained in step 1, wherein:

those data in the dataset apparently deviating from the range of recently measured data are likely outliers, which will be processed by an averaging method, i.e., replacing the outliers with the average value of recent data. If the outliers occur continuously (e.g., lasting for over 15 minutes), they will be replaced with the data of the same time step in previous years;

those global irradiances, direct irradiances, diffuse irradiance data, and photovoltaic power data, which are less than 0, are replaced with 0; and

the time information is subjected to one-hot encoding based on the number of hours and the number of weeks, wherein:

a N-bit status register is employed to encode N number of statuses, wherein each status has its own independent register bits, and only one bit is 1 at any time, for example,

natural status codes: 000, 001, 010, 011, 100, 101

after one-hot encoding: 000001,000010,000100,001000,010000,100000

Step 3: splitting the pre-processed sample dataset of the photovoltaic power stations resulting from step 2 into a training set and a testing dataset without shuffling according to an 8:2 or 7:3 proportion.

Step 4: normalizing the training set and the testing dataset resulting from step 3, respectively. As dimensional data in the datasets are dependent on their units of measure, the normalization defines a transformation rule to cause the dimensional data to fall into a relatively small bin, thereby eliminating the impact of different dimensions on the modeling process. A typical zero-mean normalization process may convert the data of different dimensions into dimensionless data, whereby to solve the issue that the measured values likely break through historical maximal and minimal values. The transformation f may be expressed as follows:

f:xᵢ→x′ᵢ,x′ᵢ∈[−1,1]

and its transformation manner is:

$${x}_{i}^{′} = \frac{{x}_{i} - {μ}_{A}}{{σ}_{A}}$$

where xᵢ, denotes the primary value, x′ᵢ denotes the normalized data, μ_{A} denotes the mean value of the variable A, and σ_{A} denotes the standard deviation of the variable A.

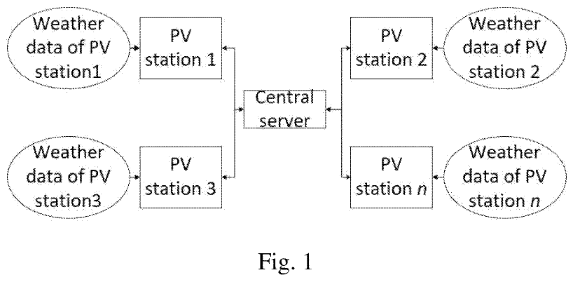

Step 5: constructing a federated learning framework. FIG. 1 illustrates a schematic diagram of the system structure of the disclosure. As illustrated in FIG. 1, the central server and the photovoltaic power stations may communicate in a wired or wireless manner, wherein the central server node may be a single-network server, a server group comprised of a plurality of network servers, or a cloud computing-based cloud comprised of a large number of computers or network servers; and the photovoltaic power stations include devices for collecting, recording, and storing weather data and photovoltaic power data, local computing resources, and network communication devices.

Step 6: building, by the central server, a global forecasting model based on forecast requirements, comprising:

an approach of building the global forecasting model, wherein

a Bayesian long short-term memory (LSTM) network model is employed to obtain time-domain characteristics of the power of a photovoltaic power station, wherein the neural network model mainly comprises a LSTM network architecture and a Bayesian variational inference architecture, wherein

an approach of building the LTSM network architecture is carried out in the manner described below:

the LSTM network architecture includes an input layer, a first LSTM layer LSTM #1, a second LSTM layer LSTM #2, a first fully connected layer Dense #1, and a second fully connected layer Dense #2; a Sigmoid function is employed as the activation function for all LSTM layers; wherein the LSTM layers are specifically expressed as follow:

iₜ=σ(Wᵢᵢxₜ+bᵢᵢ+Wₕᵢh₍ₜ₋₁₎+bₕᵢ)

fₜ=σ(W_{if}xₜ+b_{if}+W_{hf}h₍ₜ₋₁₎+b_{hf})

gₜ=tanh (W_{ig}xₜ+W_{hg}h₍ₜ₋₁₎+b_{hg})

oₜ=σ(Wᵢₒxₜ+bᵢₒ+Wₕₒh₍ₜ₋₁₎+bₕₒ)

cₜ=fₜ*c₍ₜ₋₁₎+iₜ*gₜ

hₜ=oₜ* tanh (cₜ)

where xₜ denotes the input to the LSTM layer at time t, iₜ denotes the input gate of the LSTM neuron at time t, fₜ denotes the forget gate of the LSTM neuron at time t, gₜ denotes the cell gate of the LSTM neuron at time t, of denotes the output gate of the LSTM neuron at time t; cₜ denotes the cell state of the LSTM neuron at time t, and hₜ denotes the hidden state of the LSTM neuron at time t; Wᵢᵢ denotes the weight of xₜ fed to the input gate, and Wₕᵢ denotes the weight of output of the hidden state of the previous time to the input gate of the current time; W_{if} denotes the weight of xₜ fed to the forget gate, and W_{hf} denotes the weight of output of the hidden state of the previous time to the input gate of the current time; W_{ig} denotes the weight of xₜ fed to the cell gate, and W_{hg} denotes the weight of output of the hidden state of the previous time to the cell gate of the current time; Wᵢₒ denotes the weight of xₜ fed to the output gate, and Wₕₒ denotes the weight of output of the hidden state of the previous time to the output gate of the current time; bᵢᵢ denotes the bias term at the input gate, and bₕᵢ denotes the bias term from the hidden state of the previous time to the input gate; b_{if} denotes the bias term from the input gate to the forget gate, and b_{hf} denotes the bias term from the hidden state of the previous time to the forget gate; b_{ig} denotes the bias term from the input gate to the cell gate, and b_{hg} denotes the bias term from the hidden state of the previous time to the cell gate; bᵢₒ denotes the bias term from the input gate to the output gate, and bₕₒ denotes the bias term from the hidden state of the previous time to the output gate. * denotes Hadamard multiplication; σ and tanh represent sigmoid and hyperbolic tangent (tanh) activation function, respectively. To ease the expression, the set of all weights and biases in the constructed LSTM network is denoted as W.

$$sigmoid : f ( x ) = \frac{1}{1 + {e}^{- x}}$$

$$tanh : f ( x ) = \frac{{e}^{x} - {e}^{- x}}{{e}^{x} + {e}^{- x}}$$

An approach of building the Bayesian variational inference architecture will be described below:

the Bayesian variational inference architecture specifically adopts Monte-Carlo Dropout; the variational inference architecture intends to create a parametric approximation distribution to replace the posterior distribution that is intractably computed in the conventional Bayesian neural network; by constantly adjusting the parameters of the approximation distribution, the approximation distribution becomes approximate to the posterior distribution, thereby solving the computation problem of the posterior distribution, which realizes parameter randomization in the neural network model so as to assess the uncertainty in the data inputting and modeling process; the Monte-Carlo Dropout is an efficient approximation approach to realize variational inference; by repetitively performing forward propagation for multiple times, a series of results are obtained, and the covariance of these results is computed to represent uncertainty; without adding computational complexity or sacrificing accuracy. This approach may realize forecasting as well as uncertainty estimation using the deep neural network, and no significant change is needed to the network structure.

First, the prior distributions P(W) of each weight and bias in the created LSTM network are initialized. Generally, independent Gaussian distribution may be employed to initialize the weight and bias W, i.e., W˜N (0, I), wherein I denotes the identity matrix.

Based on the training set which includes N pieces of data, the weather data therein is expressed as X={xᵢ|i=1, . . . , N}, and the corresponding photovoltaic power is expressed as Y={yᵢ|i=1, . . . , N}; after inputting the weather data x* newly collected in step 1 and the corresponding photovoltaic power y*, the probability density function of the photovltaic power data forecast value after the new training data is inputted may be obtained:

p(y*|x*,X,Y)=∫p(y*|x*,W)p(W|X,Y)dW

and the corresponding standard variation of the predictive photovoltaic power distribution is:

Var(y*|x*)=Var[E(y*|W,x*)]+E[var(y*|W,x*)]

where the first term in the right side of the equation represents modeling uncertainty, and the second term refers to weather data measurement uncertainty.

The posterior distribution p(W|X, Y) in the probability density function of the photovoltatic power data forecast value may be computed based on the Bayesian method:

$$p ( W \vert X , Y ) = \frac{p ( W ) p ( X , Y \vert W )}{p ( X , Y )}$$

However, in practice, due to nuisance of neural network parameters, the posterior distribution p(W|X,Y) is usually intractable to compute. Therefore, a variational inference approach is employed to approximately compute the posterior distribution. A distribution q(W) is set to approximately fit the posterior distribution p(W|X,Y). q(W) is defined below:

q(W)=pN(m,σ²)+(1−p)N(0,σ²)

where p∈[0,1] denotes the probability of not performing dropout, the value of which is for example 0.2 or 0.3; m is the variational parameter therein, for adjusting the distribution mean value; in this application, the variance σ² of the approximation distribution is set to 0.

Kullback-Leibler divergence is defined to measure the distance between the posterior distribution p(W|X,Y) and the set approximate distribution q(W); the smaller the KL divergence, the closer the two distributions are deemed. The KL divergence between the two distributions is:

KL(p(W|X,Y)∥q(W))=−∫q(W)log p(yᵢ|xᵢ_{²}W)dW+KL(q(W)∥P(W))

where xᵢ ∈X, yᵢ ∈Y denotes each sample in X, Y in the training set.

Based on the definition of q(W), the problem of resolving the minimum value of KL(p(W|X,Y)∥q(W)) may be approximated as L2 normalization of the variational parameter m.

Further, the first term in the right side of the equation may be transformed as:

$$- \int q ( W ) log p ( Y \vert X , M ) dW = - {\sum }_{n = 1}^{N} \int q ( W ) log p ( {y}_{n} \vert {x}_{{n}^{2}} W ) dW$$

where −∫q(W) log p(yₙ|xₙ_{²}W)dW may be computed by Monte-Carlo integral approximation; the estimated posterior distribution is sampled to obtain the sample value Ŵ of the weight and bias of the neural network; the integral form is transformed into the sum form, obtaining the unbiased estimation of log p(yₙ|xₙ,Ŵ)dW, further deriving −∫q(W) log p(Y|X,W)dW.

Now, the KL divergence between the two distributions may be expressed as:

$$K L ( p ( W \vert X , Y ) ‖ q ( W ) ) = - {\sum }_{n - 1}^{N} log p ( y \vert {x}_{{n}^{2}} \hat{W} ) + K L ( q ( W ) ‖ p ( W ) )$$

For KL(q(W)∥p(W)), when the neural network has a very large number of parameters, there is:

$$K L ( q ( w ) ‖ p ( w ) ) = \frac{p}{2} {m}^{t} m$$

In view of the above, the object function of the global forecasting model built in step 6 is:

$$min KL ( p ( W \vert X , Y ) ‖ q ( W ) ) = - {\sum }_{n = 1}^{N} log p ( {y}_{n} \vert {x}_{{n}^{2}} + \frac{p}{2} {m}^{t} m$$

For the approximate distribution q(W), when new weather data x* is inputted, the probability density function q(y*|x*) of the forecast value y* outputted by the neural network is:

q(y*|x*)=∫p(y*|x*,W)q(W)dW

When the forward propagation process is carried out for multiple times, since dropout stochastically changes the neuron communication status in each forward propagation process and the actual network architecture at each forward propagation is not always the same, the same input will yield a different output forecast value. Suppose the mathematic expression regarding the input weather data and the output forecast value of the neural network is:

ŷ=f^{Ŵ}^{ⁱ}(x)

When the neural network constructed in step 6 is subjected to T times of forward propagation process using the Monte Carlo Dropout technique, the desired approximation of the forecast value may be deemed as the mean value of the output forecast values resulting from the T times of forward propagation process of the neural network, namely:

$${E}_{q ( {y}^{*} \vert {x}^{*} )} ( {y}^{*} ) \approx \frac{1}{T} {\sum }_{t = 1}^{T} {f}^{{W}^{t}} ( {x}^{*} )$$

Therefore, when the new weather information x* is inputted, the predicted photovoltaic power ŷ* may be approximated as:

$${\hat{y}}^{*} \approx \frac{1}{T} {\sum }_{t = 1}^{T} {f}^{{W}^{t}} ( {x}^{*} )$$

When the T times of stochastic forward propagation process are carried out, the uncertain σ²_{Epistemic} during the modeling process may be expressed as:

$${σ}_{Epistemic}^{2} = \frac{1}{T} {\sum }_{t = 1}^{T} {( {f}^{{W}^{t}} ( {x}^{*} ) - {\hat{y}}^{*} )}^{2}$$

and the uncertainty σ²_{Aleatoric} of the training data X and Y caused by factors such as instrument error during data collection may be expressed as:

$${σ}_{Aleatoric}^{2} = \frac{1}{N} {\sum }_{i = 1}^{N} {( {y}_{i} - {\hat{y}}^{*} )}^{2}$$

Therefore, the uncertainty σ² of the photovoltaic power forecast may be approximated as:

σ²≈σ²_{Epistemic}+σ²_{Aleatoric}

Then, the corresponding confidence interval under different confidence levels is:

[ŷ*−z_{a/2}σ,ŷ*+z_{a/2}σ]

L where α denotes the quantile corresponding to the confidence level, and z_{a/2} denotes the corresponding standard score, which may be obtained from table lookup. Typical confidence levels include 99%, 95%, 90%, and 50%.

Step 7: defining a training error function, an optimizer, and a learning rate of the global forecasting model built in step 6, and distributing the network architecture and the initialized parameters to each photovoltaic power station;

the training error function selects a mean square error (MSE):

$$MSE = \frac{1}{K} {\sum }_{i = 1}^{K} ( {y}_{i} - {\hat{y}}_{i}^{*} )$$

where yᵢ and y*ᵢ denote the i^{th} measured photovoltaic power and the corresponding neural network forecast value in the dataset, respectively, and K denotes the number of pieces of the data in use.

The optimizer and the learning rate are selected in the following manner:

To fit the federated learning framework, the optimizer for neural network training uses the stochastic gradient descent (SGD) approach; and the learning rate may be set to 0.01, 0.001 or 0.1. The training batch size for individual inputs may select 128 or 64. Particularly, the batch size may be adjusted based on the RAM (Random Access Memory) size or graphics card memory size of the computing device equipped to the photovoltaic power station, which may be minimally 1.

Step 8: selecting, by the central server based on its communication statuses with respective photovoltaic power stations, a plurality of photovoltaic power stations for forecasting model training and feedback;

wherein the photovoltaic power stations participating in the training and feedback are selected in a manner described below:

the central server selects, based on its communication statuses with respective photovoltaic power stations, a plurality of photovoltaic power stations for forecasting model training and feedback. For example, the central server performs selection based on the ping value of respective nodes, wherein the photovoltaic power stations with a ping value less than 500 ms are selected to participate in the training; the selection may also be performed based on the upload/download rate of respective photovoltaic power stations, wherein the threshold rate may be set based on the connection manner between the central server and the respective photovoltaic power stations (e.g., the rate of downloading the photovoltaic power station forecasting model is greater than 300 kb/s). The unselected photovoltaic power stations continue using their current local forecasting models.

Step 9: subjecting each selected station from step 8 to model training and testing using the local training set and testing dataset prepared in step 4, and updating the local forecasting model;

wherein the updating the local model is performed in a manner described below:

if the testing result satisfies the set threshold, the testing passes; and then the local model is saved and reported to the central server. If the testing result does not satisfy the set threshold, upload is discarded, and the global model downloaded in the last round continues in use. The threshold may be set such that the testing error MSE is less than 5% to 15% of the maximum value, which may rise as the time scale of advance forecast increases; generally, the ultra-short-term and short-term forecasts with 5 to 60 advance minutes may select threshold 5% to 10%, while the threshold for day-ahead forecast may be relaxed to 15%.

Step 10: subjecting each photovoltaic power station to photovoltaic power probabilistic forecasting, wherein after the weather data collected in the time step preceding the to-be-forecasted time are processed according to the method of step 2 at all stations, the photovoltaic power forecast values for designated stations at the to-be-forecasted time under different confidence levels may be obtained with the processed data serving as inputs to the existing local forecasting model. Typical confidence levels include 99%, 95%, 90%, and 50%.

Step 11: receiving, by the central server, the local testing models resulting from step 9 which pass the testing, and updating the global forecasting model.

Now, an optimization policy for the central server's reception of the local forecasting model will be described:

to avoid the central server from long-time waiting for feedback from an operating node, the training speed of the model is decreased, wherein the server node only receives the local model fed back in a preset time step. For example, the server node may activate a timer after distributing the to-be-trained model, and upon expiration of the preset time step, the reception pipeline may be closed to reject further reception of the local model; or, the local model received after expiration of the preset time step is directly discarded. Within the preset time step, the central server receives local models fed back from the plurality of photovoltaic power stations selected in step 6. Dependent on different forecast advance time, the preset feedback waiting time step may be set to: 2 to 3 minutes for ultra-short term; 10 to 20 minutes for short term; and 30 to 50 minutes for day ahead. The preset feedback waiting time step may be appropriately adjusted based on different communication link bandwidths, thereby ensuring reception of enough feedback samples and reservation of enough global model update time and model distribution time.

The method of updating the global forecasting model is described as follows:

updating the to-be-trained model based on a plurality of local models fed back from the photovoltaic power stations and corresponding weight coefficients. The to-be-trained model is updated according to the following equation:

$${G}^{′} = α G + \frac{1 - α}{n} {\sum }_{i = 1}^{n} {G}_{i}$$

where G′ denotes the updated global model, G denotes the pre-update global model, Gᵢ denotes the i^{th} local model, and a denotes the pre-update global model weight, which may be selected from 0 to 1 as needed, and n denotes the number of local models fed back.

Step 12: distributing, by the central server, the updated global model to all photovoltaic power stations. For those photovoltaic power stations failing to be distributed, distribution is retried. After the number of times of retry reaches 3 to 10 times, retry is suspended and recorded to issue an alert. The number of times of retry may be adjusted based on link condition and forecast advance time.

Step 13: repeating steps 8 to 12 to rolling update the global model. In view of the above, the global model may be updated with the local data of photovoltaic power stations based on the federated learning framework, which stepwise implements short-term or ultra-short term photovoltaic power probabilistic forecasting for the photovoltaic power stations within a certain region, thereby resolving the issues of data privacy and security protection and providing a more comprehensive future photovoltaic power information for grid operation.

### Embodiment 2

The disclosure is applied to day-ahead forecast testing of the weather data and photovoltaic power data collected in Ningxia, P.R. China during the period from July 2006 to November 2018. In the testing, the federated learning framework includes two photovoltaic power stations and one central server.

In step 1, both photovoltaic power stations participate in the federated learning framework; the collected and recorded weather information of each photovoltaic power station includes atmospheric temperature C), atmospheric pressure (hPa), and relative humidity (%) at 2 m height, upper-air wind speed at 10 m height, upper-air wind direction at 10 m height, global irradiances, diffuse irradiances, and direct irradiances. The interval for collection and recording is 30 minutes.

During data pre-processing in step 3, no continuous outliers occur to the two photovoltaic power stations; therefore, the outliers in the datasets are replaced with the average value, and all global irradiances, direct irradiances, diffuse irradiance data and photovoltaic power data, which are less than 0, are replaced with 0; the hour data are encoded with 24-bit status codes, and the week data are encoded with 52-bit status codes.

Hyper parameters of the global forecast neural network model built in step 6 are set as follows:

LSTM #1: 128 neurons, dropout=0.2

LSTM #2: 128 neurons, dropout=0.2

Dropout #1:0.2

Dense #1: 64 neurons

Dropout #2:0.2

Dense #2 (output layer): 32 neurons;

where independent Gaussian distribution is employed to initialize the weight and bias W; in the approximate distribution q(W), p is valued to 0.2; when the Monte Carlo Dropout technique is employed, the global forecast neural network model is subjected to T=10 times of forward propagation processes; in this way, the photovoltaic power and uncertainty at a future time may be forecasted, further obtaining the photovoltaic power confidence interval under a confidence level.

In step 7, the optimizer and the learning rate are selected as such: 0.01 for the learning rate, and 64 for the training batch size of individual inputs.

In step 8, parameters of the photovoltaic power stations participating in training and feedback are set as such: selecting the stations with a photovoltaic power station forecasting model download rate being greater than 300 kb/s; in this example, the two photovoltaic power stations always meet this condition.

In step 9, the set threshold is 15%.

In step 10, the confidence level for photovoltaic power probabilistic forecast is 99%.

In step 11, the preset feedback waiting time step is 30 minutes, and the weight of the pre-update global model in updating the global forecasting model is 0.2.

In step 12, the number of times of the central server's retry to distribute the updated global model to all photovoltaic power stations is set to 5.

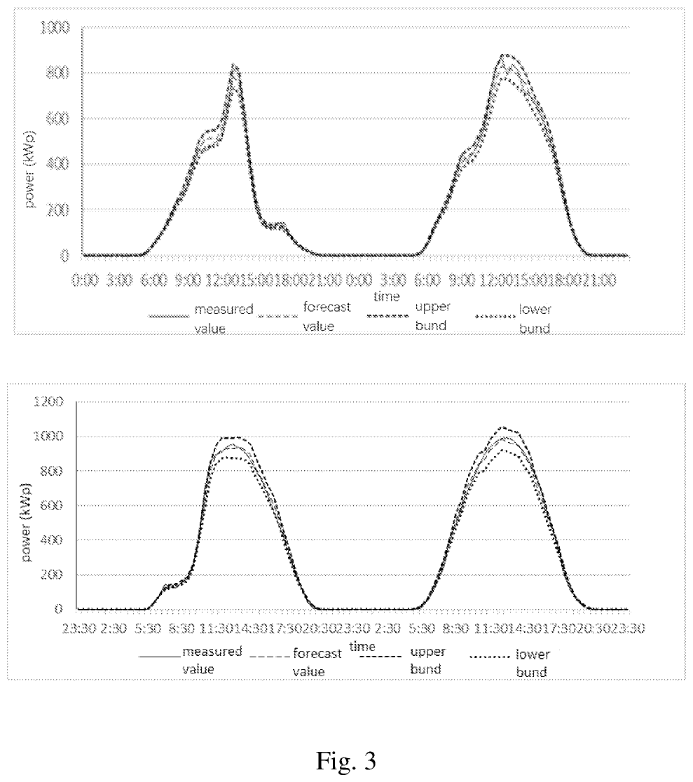

The forecast result from rolling forecast with reference to step 13 is shown in FIG. 3. The forecast result reveals that, for two different stations, the solid line representing the measured values and the dashed line representing the forecast values are always close in sunny and cloudy weather, falling into the forecast confidence interval determined by the upper bund and lower bund. When the weather condition fluctuates, the corresponding forecast interval range is broadened, which may alert a grid dispatcher to take regulation measures such as making more spinning reserve; when the weather condition is relatively stable, the corresponding forecast interval range is relatively small, such that the spinning reserve may be downscaled to improve the overall cost-effectiveness. It is calculated that the forecast precision index MSE of the two stations at the time is 4.38%, which can satisfy the precision requirement of day-ahead forecast.

The basic principles, main features, and advantages of the disclosure have been illustrated and described above. Those skilled in the art should understand that the disclosure is not limited to the examples described above. The present disclosure may have various modifications and improvements without departing from the spirit and scope of the disclosure, and all such modifications and improvements fall into the scope of the disclosure. The protection scope of the disclosure is defined by the appended claims and their equivalences.

I/We claim:

1. A federated learning-based regional photovoltaic power probabilistic forecasting method, comprising steps of:
step 1: pinpointing all photovoltaic power stations within a region which participate in a federated learning framework for probabilistic forecasting, collecting weather information and corresponding photovoltaic power variables within a time step, and grouping the variables according to time order into a sample dataset;
step 2: pre-processing the sample dataset obtained in step 1;
step 3: splitting the processed sample dataset of the photovoltaic power stations resulting from step 2 into a training set and a testing set according to a predetermined proportion;
step 4: normalizing the training set and the testing set resulting from step 3;
step 5: constructing the federated learning framework;
step 6: building, by a central server based on a forecast requirement, a global forecasting model;
step 7: defining a training error function, an optimizer, and a learning rate of the global forecasting model built in step 6, and distributing network architecture and initialized parameters to each photovoltaic power station;
step 8: selecting, by the central server based on its communication status with each photovoltaic power station, a plurality of photovoltaic power stations to perform forecasting model training and feedback;
step 9: performing model training and testing using the local training set and testing set prepared in step 4 to each photovoltaic power station selected in step 8, respectively, and updating local forecasting models;
step 10: performing photovoltaic power probabilistic forecasting to each of the selected photovoltaic power stations;
step 11: receiving, by the central server, the local forecasting models in step 9 which pass testing, and updating the global forecasting model;
step 12: distributing, by the central server, the updated global model to all photovoltaic power stations;
step 13: repeating steps 8 to 12 to rolling update the global model.

2. The federated learning-based regional photovoltaic power probabilistic forecasting method of claim 1, wherein the weather information includes global irradiances, direct irradiances, diffuse irradiance data, atmospheric temperatures, atmospheric pressures, wind speeds, wind directions, and relative humidity.

3. The federated learning-based regional photovoltaic power probabilistic forecasting method of claim 1, wherein the step 2 further comprises: for outliers in the sample dataset which apparently deviate from a range of recent measured data, replacing the outliers with the average value of the recent measured data;
for the global irradiances, direct irradiances, diffuse irradiance data, and photovoltaic power data, which are less than 0, in the sample dataset, replacing them with 0;
for time information, performing one-hot encoding to number of hours and number of weeks in the sample dataset, comprising:
encoding N number of statuses using a N-bit status register, wherein each status has its own independent register bits, and at any time, only one bit in the register bits is 1.

4. The federated learning-based regional photovoltaic power probabilistic forecasting method of claim 1, wherein the step 3 further comprises: the splitting the sample dataset refers to splitting the sample dataset into a training set and a testing set without shuffling in accordance with an 8:2 or 7:3 proportion.

5. The federated learning-based regional photovoltaic power probabilistic forecasting method of claim 1, wherein in step 4, the normalizing enables different dimensional data other than time information to be transformed into dimensionless data with a range of [0, 1] according to an equation of:
$${x}_{i}^{′} = \frac{{x}_{i} - {μ}_{A}}{{σ}_{A}}$$
where xᵢ denotes the original numerical value, xᵢ denotes normalized data, μ_{A} denotes the mean value of variable A, and σ_{A} denotes the standard deviation of the variable.

6. The federated learning-based regional photovoltaic power probabilistic forecasting method of claim 1, wherein in step 5, the federated learning framework comprises a central server and respective photovoltaic power stations, the central server being responsible for coordinating a forecasting model training process, and the respective photovoltaic power stations participating in updating the forecasting model and computing forecast values.

7. The federated learning-based regional photovoltaic power probabilistic forecasting method of claim 1, wherein the step 6 further comprises: computing a photovoltaic power station power forecast value using a Bayesian long short term memory neural network model, wherein the neural network model mainly comprises a long short-term memory network architecture and a variational inference architecture, wherein the variational inference architecture is implemented using Monte Carlo Dropout technique; and finally, forecasts in consideration of uncertainty are subjected to multiple times of forward propagation training to obtain different results, wherein the photovoltaic power station power forecast value is characterized by variance of the different results.

8. The federated learning-based regional photovoltaic power probabilistic forecasting method of claim 7, wherein in step 7, the model training error function selects mean square error (MSE), expressed as:
$$MSE = \frac{1}{K} {\sum }_{i = 1}^{K} ( {y}_{i} - {\hat{y}}_{i}^{*} )$$
where yᵢ and ŷ*ᵢ denote the i^{th} measured photovoltaic power in the dataset and corresponding Bayesian long short term memory neural network forecast value, respectively, and K denotes the number of pieces of data in use.

9. The federated learning-based regional photovoltaic power probabilistic forecasting method of claim 1, wherein the step 9 further comprises: if a testing result error of the model is less than a set threshold, using the training model to perform forecasting; otherwise, using the global model of the last round to perform forecasting.

10. A regional energy coordinated control system adapted to implement the federated learning-based regional photovoltaic power probability forecasting method of claim 1, wherein the regional energy coordinated control system comprising:
a central server;
edge computing nodes of each plant; and
communication lines, through which the central server communicates with the edge computing nodes of different photovoltaic plants belonging to different entities;
wherein the central server generates a probabilistic photovoltaic power forecast result.
